(19) United States
(12) Patent Application Publication
(10) Pub. No.: US 2010/0048781 A1
(43) Pub. Date: Feb. 25, 2010

(54) Filled Plastic Material Composition

(75) Inventors: John D. Schofield, Bury (GB); Dean Thetford, Norden (GB); Patrick J. Sunderland, Rossendale (GB)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: LUBRIZOL LIMITED, Derby, Derbyshire (GB)

(21) Appl. No.: 12/518,528

(22) PCT Filed: Dec. 14, 2007
(86) PCT No.: PCT/EP2007/064000

§ 371 Date: Nov. 6, 2009

Related U.S. Application Data
(60) Provisional application No. 60/869,973, filed on Dec. 14, 2006.

(51) Int. Cl. C08K 5/52

(52) U.S. Cl. 524/140

(57) ABSTRACT

The invention relates to a composition containing a particulate solid, plastic material (such as a vinyl chloride polymer), and a compound containing an acidic group.

### FIELD OF INVENTION

The invention relates to a composition containing a particulate solid, plastic material (such as a vinyl chloride polymer), and a compound containing an acidic group.

### BACKGROUND OF THE INVENTION

In plastic materials such as polyvinyl chloride, the use of fillers is known. The presence of the fillers is known as a means of imparting dimensional rigidity and lower costs of final plastic materials. However, advantages of fillers are balanced against at least one disadvantage including (i) slower processing during manufacture of the plastic materials, and (ii) diminished impact strength. Further, the presence of fillers tend to increase energy costs associated with manufacturing plastic materials because it is desirable to have uniform distribution of the filler in the plastic materials. Uniform distribution of fillers typically results in the consistent properties of the plastic materials. Consequently, only low loadings of filler are employed in production of plastic materials, particularly polyvinyl chloride.

In order to overcome a number of the difficulties highlighted above, attempts have been made to employ coupling agents or other additives to the filler to promote compatibility with plastic materials. Attempts include disclosures in U.S. Pat. Nos. 3,344,107, or 3,404,023, or 3,926,873, or 4,094,853, or 4,098,758, or 4,294,752.

U.S. Pat. No. 4,294,752 discloses the use of a lower alkoxylated alkyl acid phosphate ester as an additive in filled vinyl chloride polymer compositions to provide improved processing conditions and impact resistance of the filled plastic.

Hence, there is a need for providing a composition with plastic materials and fillers, whilst overcoming problems associated with the art. The present invention provides such a composition.

### SUMMARY OF THE INVENTION

In one embodiment, the invention provides a composition comprising a particulate solid, a plastic material (such as a vinyl chloride polymer, such as polyvinyl chloride (PVC) or a chlorinated poly vinyl chloride (CPVC)) and a compound of Formula (1), or salts thereof:

Y-A-O—B—Z Formula (1)

wherein

Y is independently a group RO— or a group Z—B—;

R is independently a C1-18 hydrocarbyl group, or a C1-18 hydrocarbonyl group;

Z is an acidic group;

A is independently —[OCH₂CH(R′)]ₘ—, or —[CH(R′)CH₂O]ₙ—;

B is independently a hydroxycarboxylic group, —[OCH₂CH(R′)]ₘ—, or —[CH(R′)CH₂O]ₙ—;

R′ is independently H, —CH₃, or —CH₂CH₃; and

m and n independently vary from 1 to 1000, or 1 to 500, or 1 to 500, or 1 to 70.

In one embodiment, the invention provides a composition comprising a particulate solid, a plastic material (such as a vinyl chloride polymer, such as a polyvinyl chloride or a chlorinated poly vinyl chloride) and a compound (which may also be referred to as a dispersant) obtained/obtainable by reacting a polyethylene glycol with a molar excess of a hydroxycarboxylic acid containing from 4 to 17 carbon atoms or lactone thereof and/or with a C₃₋₄-alkylene oxide to form a polymeric diol and phosphating the diol by reaction with a phosphating agent to give a phosphate ester. A more detailed description of the compound is disclosed in European Patent Application EP 0 765 356.

In one embodiment, the invention provides a composition comprising a particulate solid, a plastic material (such as a vinyl chloride polymer, such as a polyvinyl chloride or a chlorinated poly vinyl chloride), and Z is a partial ester of a phosphate (or sulphate).

In one embodiment, the invention provides a composition comprising a particulate solid, a plastic material (such as a vinyl chloride polymer, such as a polyvinyl chloride or a chlorinated poly vinyl chloride), and Z is a mono- or di-ester of a phosphate, or mono-sulphate.

In one embodiment, the invention provides a method of filling a plastic material (such as a vinyl chloride polymer, such as a polyvinyl chloride or a chlorinated poly vinyl chloride), comprising supplying to the plastic material a particulate solid and a compound of Formula (1).

In one embodiment, the invention provides for the use of a compound selected from the group consisting of Formula (1), a partial ester of a phosphate, a partial ester of a sulphate, and mixtures thereof as a dispersant for filler in a vinyl chloride polymer.

### DETAILED DESCRIPTION OF THE INVENTION

The present invention provides a composition as disclosed herein above.

In one embodiment, the Z includes an inorganic acidic group. Examples of an inorganic acidic group include a sulphur group, or phosphorus group, or mixtures thereof.

In one embodiment, Z includes a phosphate or sulphate acidic group.

In one embodiment, Z includes a phosphate acidic group.

In one embodiment, the compound of Formula (I) is dispersed within the composition. In one embodiment, the compound of Formula (I) is uniformly dispersed within the composition.

In one embodiment, the plastic material includes a vinyl chloride polymer. In one embodiment the vinyl chloride polymer is selected from the group consisting of polyvinyl chloride and chlorinated polyvinyl chloride. The vinyl chloride polymer may be a homopolymer or a copolymer. In one embodiment the chlorinated PVC may have a chlorine content of from 50 to 75 weight %, in another embodiment the chlorine content is from 55 to 70 weight %, desirably from 57 to 68 weight %.

In one embodiment, the vinyl chloride polymer includes a homopolymer.

In one embodiment, the vinyl chloride polymer includes a copolymer.

When a vinyl chloride copolymer is employed as the plastic material in the invention, the copolymer may be formed by copolymerising vinyl chloride with a comonomer. Examples of suitable comonomers include vinyl esters such as vinyl acetate, alkyl (meth)acrylates such as ethyl acrylate, butyl acrylate, methyl methacrylate, acrylonitrile, dialkyl vinyl phosphonates (such as bis(betachloroethyl)vinylphosphonate) and chlorinated PVC.

A more detailed description of the phosphate ester dispersant as disclosed in European Patent Application EP 0 765 356, specifically in paragraphs 7 to 24, and are hereby incorporated by reference. The phosphate ester may be in the free acid form or it may form a salt with an alkali metal, ammonia, an amine, alkanolamine or quaternary ammonium cation. The phosphate ester group may also be further partially esterified by reaction with an alcohol or may form a salt with an alkanolamine.

In one embodiment, the invention provides a composition comprising a particulate solid, a plastic material (such as a vinyl chloride polymer, such as a polyvinyl chloride or a chlorinated poly vinyl chloride) and a compound derived from a polymeric diol obtained/obtainable by reacting a polyethylene glycol with a molar excess of a hydroxycarboxylic acid. A more detailed description of the compound is disclosed in European Patent Application EP 0 765 356.

In one embodiment, A and B are —[OCH₂CH₂]ₘ—, or —[CH₂CH₂O]ₙ—.

In one embodiment, A and B are independently —[OCH₂CH(CH₃)]ₘ—, or —[CH(CH₃)CH₂O]ₙ—.

In one embodiment, A and B are independently —[OCH₂CH(CH₂CH₃)]ₘ—, or —[CH(CH₂CH₃)CH₂O]ₙ—.

In one embodiment, A and B are mixtures of (i) at least one of —[OCH₂CH(CH₃)]ₘ—, or —[CH(CH₃)CH₂O]ₙ—; and (ii) at least one of —[OCH₂CH(CH₂CH₃)]ₘ—, or —[CH(CH₂CH₃)CH₂O]ₙ—.

In one embodiment, A and B are mixtures of (i) at least one of —[OCH₂CH(CH₃)]ₘ—, or —[CH(CH₃)CH₂O]ₙ—; and (ii) at least one of —[OCH₂CH₂]ₘ—, or —[CH₂CH₂O]ₙ—.

In one embodiment, A is —[OCH₂CH(CH₃)]ₘ—, or —[CH(CH₃)CH₂O]ₙ—; and B is —[OCH₂CH₂]ₘ—, or —[CH₂CH₂O]ₙ—.

In one embodiment, A is —[OCH₂CH₂]ₘ—, or —[CH₂CH₂O]ₙ—; and B is —[OCH₂CH(CH₃)]ₘ—, or —[CH(CH₃)CH₂O]ₙ—.

In one embodiment, A and B is —(O—(CH₂)₄)ₘ—, or —((CH₂)₄—O)ₙ—. Typically, the group —(O—(CH₂)₄)ₘ—, or —((CH₂)₄—O)ₙ— may be derived from polytetrahydro furan.

In one embodiment, the invention provides a composition comprising a particulate solid, a plastic material (such as a vinyl chloride polymer, or a chlorinated poly vinyl chloride) and a partial ester (includes mono- or di-esters) of a phosphate a compound of Formula (1a); and salts thereof: J-[PO)_{w}(EO)_{q}]—H.

Formula (1a), wherein EO is ethylene oxide repeat unit; PO is propylene oxide repeat unit; J is a C₁₋₁₈—O— group, or a H-(EO)ₜ group; t and q are independently 1 to 50; and w is 1 to 70. A more detailed description of the compound of Formula (1a) is described in International publication WO 97/42252 A1. In particular, page 1, line 30 to page 3, line 2, and are hereby incorporated by reference.

In one embodiment, the invention provides a composition comprising 1 to 50 wt. % of a particulate solid, 45 to 98.99 wt. % of a plastic material (such as a vinyl chloride polymer, or a chlorinated poly vinyl chloride), and 0.01 to 5 wt. % of a compound of Formula (1).

In one embodiment, the invention provides a composition comprising 1 to 50 wt. % of a particulate solid, 47 to 98.99 wt. % of a plastic material (such as a vinyl chloride polymer, or a chlorinated poly vinyl chloride), and 0.01 to 3 wt. % of a compound of Formula (1).

The particulate solid may be any solid material which is used with polymeric materials and specifically includes such solids used as fillers. The particulate solids may be in the form of a granular material or in the form of a powder, often a blown powder. Examples include calcium carbonate, calcium sulphate, calcium oxide, barium sulphate, barium carbonate, magnesium oxide, magnesium hydroxide, titanium dioxide, iron oxide, calcium and magnesium silicates, aluminosilicates, kaolin, mica, talc, chalk, metal fibres and powders, zinc, aluminium, aluminium trihydroxide, glass fibres, refractory fibres, carbon black including reinforcing and non-reinforcing carbon black, alumina, quartz, wood flour, powdered paper/fibre, asbestos, crysatille, anthophylite, crocidolite, wollastonite, attapulgite and the like, particulate ceramic materials such as alumina, silica, zirconia, titania, silicon nitride, aluminium nitride, boron nitride, silicon carbide, boron carbide, mixed silicon-aluminium nitrides and metal titanates; particulate magnetic materials such as the magnetic oxides of transition metals, often iron and chromium, e.g., gamma-Fe₂O₃, Fe₃O₄, and cobalt-doped iron oxides, ferrites, e.g., barium ferrites; and metal particles, for instance metallic iron, nickel, cobalt, copper and alloys thereof.

In one embodiment, the particulate solid (or filler) is selected from the group consisting of calcium carbonate, magnesium carbonate, magnesium hydroxide, alumina trihydrate, silica, alumina silicate, magnesium silicate, magnesium oxide, iron oxide, diatomaceous earth, hydrated silicates, calcium oxide, mica, talc, kaolin, and bentonite. In one embodiment, the inorganic particulate includes calcium carbonate.

In one embodiment, the particulate solid is pre-coated with the compound of Formula (1).

Optionally, the compositions of the invention further comprise other conventional additives in conventional amounts, such as: plasticizers, flame retardants, lubricants, impact modifiers, blowing agents, or stabilizers.

The following examples provide illustrations of the invention. These examples are non exhaustive and are not intended to limit the scope of the invention.

### EXAMPLES

Dispersant 1: is Example 44 of U.S. Pat. No. 5,785,894, (phosphate ester of Pluronic 17R4).

Dispersant 2: is Example 13 of U.S. Pat. No. 5,981,624, (phosphate ester of Synperonic PE/L81).

### Comparative Examples

are prepared by mixing 100 parts polyvinyl chloride (Oxy Vinyls™ 225), 3 parts of Arkema Durastrength™ 200 (acrylic modifier), 0.4 parts calcium stearate, 0.1 parts polyethylene wax (Honeywell™ AC-6A), 0.8 parts paraffin wax (Ferro Petrac®165 wax), 1 part organo-tin stabiliser (Akzo Nobel T5201), and 20 parts calcium carbonate (Camel Fine ST) in a Henschel at 60° C., to form mixtures. The mixture is then processed in a Brabender apparatus at 3 different speeds. The speeds are 15 rpm, 25 rpm and 35 rpm. The Brabender apparatus is used with barrel temperatures of 168° C. (335° F.), 185° C. (365° F.), and 190° C. (375° F.). The average torque readings and output of material from the Brabender Intelli-Torque Plasti-Corder torque rheometry system are recorded.

Compositions of the invention are prepared in a similar manner as the comparative examples, except, 1.27 parts of dispersant 1 or dispersant 2 are added. The results obtained for the comparative examples and examples of the invention are as follows:

| | | | Brabender Results | |
|---|---|---|---|---|
| | | Speed of | | Product |
| | | Rotation | Torque | Processed |
| Composition | Dispersant | (rpm) | (mg) | (g/min) |
| Comparative 1 | None | 15 | 3535 | 45 |
| Example 1 | Dispersant1 | 15 | 2744 | 41.5 |
| Example 2 | Dispersant 2 | 15 | 3525 | 50.3 |
| Comparative 2 | None | 25 | 4484 | 69.8 |
| Example 3 | Dispersant1 | 25 | 2983 | 62.1 |
| Example 4 | Dispersant 2 | 25 | 4094 | 77.5 |
| Comparative 2 | None | 35 | 5066 | 92.1 |
| Example 5 | Dispersant1 | 35 | 3130 | 82.9 |
| Example 6 | Dispersant 2 | 35 | 4472 | 103.8 |

Overall, the data demonstrates that the compositions of the invention are capable of at least one of (i) reducing the torque of the polyvinyl chlorides formed; or (ii) and/or increasing the throughput of mixture through the Brabender, thus allowing for more efficient production of polyvinyl chloride.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A composition comprising a particulate solid, a vinyl chloride polymer and a compound of Formula (1) or salts thereof:
Y-A-O—B—Z Formula (1)
wherein
Y is independently a group RO— or a group Z—B—;
R is independently a C1-18 hydrocarbyl group, or a C1-18 hydrocarbonyl group;
Z is phosphate or sulfate acidic group;
A is independently —[OCH₂CH(R′)]ₘ—, or —[CH(R′)CH₂O)]ₙ—;
when Y is RO—, then B is independently a hydroxycarboxylic group,
when Y is Z—B—, then B is a hydroxycarboxylic group, —[OCH₂CH(R′)]ₘ—, or —[CH(R′)CH₂O]ₙ—;
in either case R′ is independently H, —CH₃, or —CH₂CH₃; and
m and n independently vary from 1 to 1000.

2. The composition of claim 1, wherein m and n are independently 1 to 500, or 1 to 70.

3. The composition of claim 1, wherein A and B are —[OCH₂CH₂]ₘ—, or —[CH₂CH₂O]ₙ—.

4. The composition of claim 1, wherein A and B are independently —[OCH₂CH(CH₃)]ₘ—, or —[CH(CH₃)CH₂O]ₙ—.

5. The composition of claim 1, wherein A and B are independently —[OCH₂CH(CH₂CH₃)]ₘ—, or —[CH(CH₂CH₃)CH₂O]ₙ—.

6. The composition of claim 1, wherein A is —[OCH₂CH(CH₃)]ₘ—, or —[CH(CH₃)CH₂O]ₙ—; and B is —[OCH₂CH₂]ₘ—, or —[CH₂CH₂O]ₙ—.

7. The composition of claim 1, wherein A is —[OCH₂CH₂]ₘ—, or —[CH₂CH₂O]ₙ—; and B is —[OCH₂CH(CH₃)]ₘ—, or —[CH(CH₃)CH₂O]ₙ—.

8. (canceled)

9. (canceled)

10. The composition of claim 1, wherein Z comprises a phosphate.

11. The composition of claim 1, wherein the vinyl chloride polymer is selected from the group consisting of polyvinyl chloride and chlorinated polyvinyl chloride.

12. The composition of claim 1, wherein the vinyl chloride polymer is a homopolymer.

13. The composition of claim 1, wherein the vinyl chloride polymer is a copolymer.

14. The composition of claim 1, wherein the particulate solid is selected from the group consisting of calcium carbonate, magnesium carbonate, magnesium hydroxide, alumina trihydrate, silica, alumina silicate, magnesium silicate, magnesium oxide, iron oxide, diatomaceous earth, hydrated silicates, calcium oxide, mica, talc, kaolin, and bentonite.

15. The composition of claim 14, wherein the particulate solid is calcium carbonate.

16. The use of a compound of Formula (1) or salts thereof:
Y-A-O—B—Z Formula (1)
wherein
Y is independently a group RO— or a group Z—B—;
R is independently a C1-18 hydrocarbyl group, or a C1-18 hydrocarbonyl group;
Z is phosphate or sulfate acidic group;
A is independently —[OCH₂CH(R′)]ₘ—, or —[CH(R′)CH₂O)]ₙ—;
when Y is RO— then B is a hydroxycarboxylic group, and when Y is Z—B— then B is a hydroxycarboxylic group, —[OCH₂CH(R′)]ₘ—, or —[CH(R′)CH₂O]ₙ—;
in either case R′ is independently H, —CH₃, or —CH₂CH₃; and
m and n independently vary from 1 to 1000, as a dispersant for a particulate solid in a vinyl chloride polymer.

17. (canceled)

18. (canceled)

19. The use of claim 16, wherein the particulate solid is selected from the group consisting of calcium carbonate, magnesium carbonate, magnesium hydroxide, alumina trihydrate, silica, alumina silicate, magnesium silicate, magnesium oxide, iron oxide, diatomaceous earth, hydrated silicates, calcium oxide, mica, talc, kaolin, and bentonite.

20. A composition comprising a particulate solid, a vinyl chloride polymer and a compound obtained/obtainable by reacting a polyethylene glycol with a molar excess of a hydroxycarboxylic acid containing from 4 to 17 carbon atoms or lactone thereof and/or with a C₃₋₄-alkylene oxide to form a polymeric diol and phosphating the diol by reaction with a phosphating agent to give a phosphate ester.

21. A composition comprising a particulate solid, a vinyl chloride polymer and a compound derived from a polymeric diol obtained/obtainable by reacting a polyethylene glycol with a molar excess of a hydroxycarboxylic acid.

22. The composition of claim 21, wherein the plastic material is a vinyl chloride polymer selected from the group consisting of polyvinyl chloride and chlorinated polyvinyl chloride.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
